(19) United States
(12) Patent Application Publication
(10) Pub. No.: US 2003/0159722 A1
(43) Pub. Date: Aug. 28, 2003

(54) Apparatus for cleaning a lawnmower

(76) Inventor: Ronald E. Burkett, St. Louis, MO (US)

Correspondence Address: George L. Williamson, P.O. Box 508, Fairhope, AL, 36533, US

(21) Appl. No.: 10/082,190

(22) Filed: Feb. 26, 2002

(51) Int. Cl. B08B 3/02; B08B 9/00

(52) U.S. Cl. 134/167 R

(57) ABSTRACT

The present invention discloses a device for cleaning the underside of a lawnmower. As part of the present invention, the underside of the lawnmower may be coated with a non-stick material for ease of cleaning. Also disclosed is a cleaning ring disposed on the underside of the lawnmower having a plurality of apertures therein through which water is sprayed vertically and horizontally about the underside of the lawnmower base in order to clean the lawnmower base. Also disclosed is a hose connector for connecting a standard garden hose to the cleaning ring whereby water can be supplied thereto.

### BACKGROUND OF THE INVENTION

1. Field of the Invention

The present invention relates generally to lawnmowers and, more particularly, is concerned with an apparatus for cleaning the underside of a lawnmower.

2. Description of the Prior Art

Devices for cleaning lawnmowers have been described in the prior art. However, none of the prior art devices disclose the unique features of the present invention.

In U.S. Pat. No. 5,499,492, dated Mar. 19, 1996, Jameson disclosed a pulsating cleaning attachment which is added to an existing rotary lawn mower, and is adapted to receive a hose for cleaning the mower blade and underside surface of the lawn mower carriage. An attachment body member of the attachment includes a first upward-directed water passage selected at an angle of about thirty degrees, which passage terminates in an elliptically-shaped opening on the inner surface of said body member. This passage both forms and directs a jet stream of water exiting therefrom into and from beneath a rotating blade tip of the mower, whereby the rotating blade cuts the jet stream and creates a pulsating cleaning action for the undercarriage, blade and skirt of the mower.

In U.S. Pat. No. 5,444,967, dated Aug. 29, 1995, Meuth disclosed an assembly for permanent mounting to the deck of a power mower, enabling temporary attachment of a garden hose, for the purpose of washing the mower blade and the underside of the deck. The assembly includes a double female threaded fitting, a pipe nipple threaded to the double threaded fitting and passing through the mower deck. The tee fitting has horizontal members disposed below the deck and above the mower blade. The horizontal members are flatted in profile, to conserve space, and serve as nozzles discharging water onto the rotating blade when cleaning. A hold formed in the tee fitting allows escaping water to dislodge grass clippings from the novel assembly. The cross sectional area of the nozzles is at least equal to the cross sectional area of the other water conducting members, so that heavy, concentrated jets of water strike the rotating blade Preferably, a threaded cap is installed in the double female member when the garden ho se is not connected thereto, so that threads are prevented from clogging with plant clippings during operation of the mower.

In U.S. Pat. No. 5,312,047, dated May 17, 1994, Akers disclosed a spraying device for dousing the blade chamber of a rotary lawn mower to effect cleaning thereof An annular, D-shaped conduit is secured to the ground by a centrally disposed stake. The stake orients the flat portion of the D-shaped conduit against the ground, providing a low profile in order for the mower to be positioned over the spraying device. The annular conduit has a plurality of orifices disposed on the top surface defining first and second annular formations. The first annular formation upwardly directs a controlled spray pattern perpendicular to the ground, while the second annular formation upwardly and outwardly directs a controlled spray pattern preferably 45″ from the perpendicular. A valved extension conduit in communication with the annular conduit is releasably coupled to a water source such as a garden hose connected to a water faucet for supplying the spraying device with pressurized water.

In U.S. Pat. No. 4,442,661, dated Apr. 17, 1984, Stuart disclosed a rotary lawn mower pump including a rotary blade law mower with an upper housing having wheels connected thereto, an above housing motor with a drive shaft through the housing having a rotary blade connection portion beneath the housing, an impeller pump and a pump support fixedly connected to the impeller pump and adjustably connected to the housing. The impeller pump includes an impeller connected to the rotary blade connection portion of the drive shaft for rotation, a pump cover including a lower intake opening and a peripheral discharge positionable to discharge water out through the side of the housing of the lawn mower.

In U.S. Pat. No. 5,152,459, dated Oct. 6, 1992, Boeh disclosed a lawnmower washer apparatus which is arranged for receiving a lawnmower above a grid member, wherein the grid member is positioned above a rotary distribution head to direct water to a bottom surface of a lawnmower mounted upon the grid, and further including a corodal manifold positioned about the rotary distribution head to direct pressurized oil to a bottom surface of the lawnmower minimizing corrosion during storage thereof.

While these devices for cleaning lawnmowers may be suitable for the purposes for which they were designed, they would not be as suitable for the purposes of the present invention, as hereinafter described.

### SUMMARY OF THE INVENTION

The present invention discloses a device for cleaning the underside of a lawnmower. As part of the present invention, the underside of the lawnmower may be coated with a non-stick material for ease of cleaning. Also disclosed is a cleaning ring disposed on the underside of the lawnmower having a plurality of apertures therein through which water is sprayed vertically and horizontally about the underside of the lawnmower base in order to clean the lawnmower base. Also disclosed is a hose connector for connecting a standard garden hose to the cleaning ring whereby water can be supplied thereto.

An object of the present invention is to provide a simple and inexpensive method for cleaning the underside of a lawnmower. An additional object of the present invention is to provide a non-stick material to the base of the lawnmower for ease of cleaning. A further object of the present invention is to provide a medium for cleaning, i.e., water, which is easy to obtain and which can be connected to the present invention in an easy and efficient manner using a conventional garden hose.

The foregoing and other objects and advantages will appear from the description to follow. In the description reference is made to the accompanying drawings, which form a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views. The following detailed description is, therefore, not to be taken in a limiting sense, and the scope of the present invention is best defined by the appended claims.

### BRIEF DESCRIPTION OF THE DRAWINGS

In order that the invention may be more fully understood, it will now be described, by way of example, with reference to the accompanying drawings in which:

FIG. 1 is a plan view of the underside of a lawnmower.

FIG. 2 is an enlarged plan view of the cleaning ring of the present invention.

FIG. 3 is a side elevation view taken from FIG. 2 of the cleaning ring of the present invention.

FIG. 4 is an elevation view of the hose connector of the present invention.

### LIST OF REFERENCE NUMERALS

With regard to reference numerals used, the following numbering is used throughout the drawings.

10 present invention

12 lawnmower

14 base

16 wheels

18 blade

20 cleaning ring

22 apertures

24 apertures

26 hose connector

28 non-stick coating

30 aperture

32 threaded member

34 hose threads

36 cap

### DESCRIPTION OF THE PREFERRED EMBODIMENT(S)

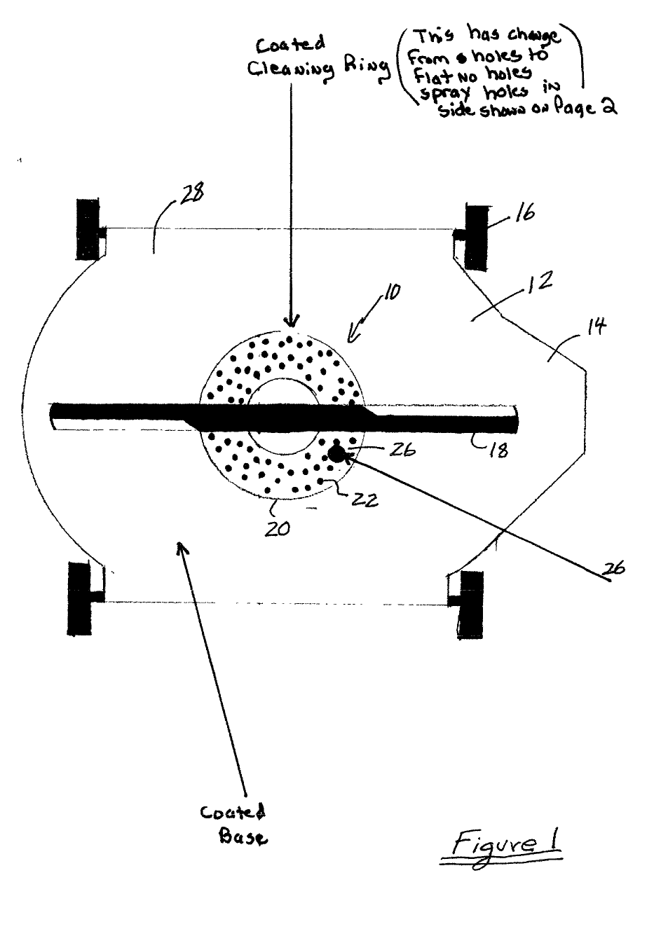

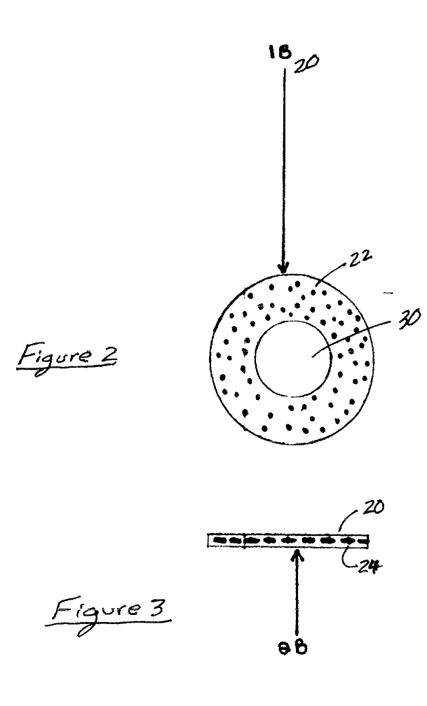

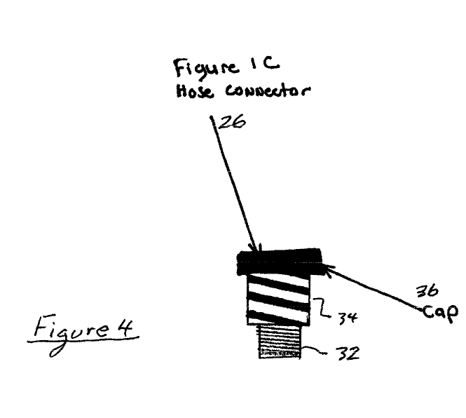

Turning now descriptively to the drawings, in which similar reference characters denote similar elements throughout the several views, FIGS. 1 through 4 illustrate the present invention being a device for cleaning the underside of a lawnmower.

Turning to FIG. 1, therein is shown a plan view of the underside of a lawnmower 12 showing the present invention 10 in operative connection therewith. Shown therein is the base of the lawnmower 14 along with its multiple wheels 16 and cutting blade 18. Also shown therein is the cleaning ring or disk 20 of the present invention having a plurality of apertures 22 therein along with a hose connector 26 whereby a conventional garden hose is connected to the present invention. The purpose of the present invention 10 is to provide a lawnmower which is self-cleaning and protected from corrosion and debris build-up. In operation, the hose (not shown) is connected to the connector 26, and water is transmitted through water passages or conduits on its interior and exists the cleaning ring 20 through the plurality of apertures 22 whereby the underside of the base 14 of the lawnmower 12 is cleaned. Furthermore, the underside of the lawnmower 12 can be coated with a non-stick material at 28 whereby the underside is completely covered so that any build-up or debris can be more easily removed. Apertures 22 are disposed on the upper and lower surfaces of ring 20.

Turning to FIG. 2, therein is shown a view of the cleaning ring 20 of the present invention showing the plurality of apertures 22 spaced about the cleaning ring 20. Note that the cleaning ring 20 has a center aperture 30 therein which is used to mount around the base of the downwardly extending shaft (not shown) from the motor of the lawnmower 12.

Turning to FIG. 3, therein is shown a side elevation view of the cleaning ring 20 of the present invention showing a plurality of apertures 24 which are present in the cleaning ring. Apertures 24 allow for a dispersion of water in generally the horizontal direction from the cleaning ring while apertures 22 disperse water in generally the vertical direction.

Turning to FIG. 4, therein is shown a side elevation view of the hose connector 26 of the present invention. The hose is shown having a mate threaded member 32 for attachment to the lower surface of the cleaning ring 20. Also shown are additional threads 34 whereby a standard water hose is connected to the hose connector 26. Additionally, therein is shown a cap 36 which is mounted on the bottom extending portion of the hose connector 26 in order to prevent the hose connector from becoming filled with dirt, debris or the like.

What is claimed to be new and desired to be protected by Letters Patent is set forth in the appended claims:

I claim:

1. An apparatus for cleaning the underside of a lawnmower, the lawnmower having a downwardly extending rotating drive shaft upon which the blade is attached, comprising:
a. means for spraying water disposed on the shaft of the lawnmower whereby the underside of the lawnmower receives spray; and,
b. means for attaching a water supply to said means for spraying water whereby a source of water can be connected thereto.

2. The apparatus of claim 1, wherein said means for spraying water disposed on the shaft of the lawnmower further comprises a disk, said disk having a plurality of outlet apertures therein, said outlet apertures for transmitting water therethrough, further said disk having a central aperture therein.

3. The apparatus of claim 2, wherein said central aperture of said disk receives the shaft of the lawnmower, said disk being disposed about the shaft of the lawnmower.

4. The apparatus of claim 3, wherein the upper surface of said disk has a plurality of outlet apertures disposed therein so that water is emitted therefrom and sprayed onto the underside of the lawnmower.

5. The apparatus of claim 4, wherein the lower surface of said disk has a plurality of outlet apertures disposed therein so that water is emitted therefrom and sprayed onto the underside of the lawnmower.

6. The apparatus of claim 4, wherein the edge of said disk has a plurality of outlet apertures disposed therein so that water is emitted therefrom and sprayed onto the underside of the lawnmower.

7. The apparatus of claim 6, wherein said means for attaching a water supply further comprises a connector for attaching a water hose thereto.

8. The apparatus of claim 7, wherein said connector is disposed on the lower side of said disk.

9. The apparatus of claim 8, further comprising a cap disposed on said connector for preventing the intrusion of dirt.

10. The apparatus of claim 9, further comprising a non-stick coating disposed on the underside of the lawnmower to enhance the washability of the lawnmower.
